(19) United States
(12) Patent Application Publication
(10) Pub. No.: US 2014/0191525 A1
(43) Pub. Date: Jul. 10, 2014

(54) USE OF CARBON NANOFIBER COMPOSITE MATERIALS IN THE MANUFACTURE OF RAILCAR COMPONENTS

(71) Applicants: Richard Ruebusch, Columbus, OH (US); Joseph PATTERSON, Columbus, OH (US)

(72) Inventors: Richard Ruebusch, Columbus, OH (US); Joseph PATTERSON, Columbus, OH (US)

(21) Appl. No.: 13/738,422

(22) Filed: Jan. 10, 2013

(51) Int. Cl. B60B 17/00

(52) U.S. Cl. CPC B60B 17/0003
USPC 295/30

(57) ABSTRACT

Systems and processes for manufacturing railcar components, such as railcar wheels, using carbon nanofiber composite materials.

### TECHNICAL FIELD

The present invention is directed to systems and processes for manufacturing railcar components, such as railcar wheels, using carbon nanofiber composite materials.

### BACKGROUND

Railcar components such as, without limitation, railcar wheels, couplers, bolsters, etc., may be subjected to extreme stresses during use. These stresses may be mechanical in nature, such as tension or shearing forces that may be produced during railcar coupling, vibratory in nature, such as may occur during rolling movement of a railcar, and/or thermal in nature, such as may occur as a result of brake application to a railcar wheel. Consequently, many railcar components must be designed and manufactured with these stresses in mind so as to prevent such stresses from causing component damage or failure.

Railcar wheels, in particular, are subjected to especially harsh stresses in use. These stresses may result from, for example, the heavy loads supported by the wheels, the continual rolling motion of the wheels and their corresponding contact with the track, and thermal cycling resulting from repeated or severe brake application and subsequent cooling. Known wheel manufacturing processes have also imparted railcar wheels with trapped residual stresses that may be problematic. The results of these stresses on railcar wheels have included, among other things, fatigue cracks and fractures, thermal checking and cracking, and wheel deflection.

To this end, a number of railcar wheel designs have been proposed over the years with the goal of improving wheel strength, durability and/or heat dissipation. Exemplary railcar wheel designs may be found for example, in U.S. Pat. Nos. 3,038,755; 4,145,079; 4,471,990; 5,039,152; and 5,333,926.

One obvious way to help ensure that a given railcar component such as a railcar wheel can sufficiently withstand the stresses to which it is subjected, is to overdesign the component in terms of its size. In other words, railcar components such as wheels may be provided with a thickness and/or other dimensions that are extremely robust. The materials used to manufacture railcar components are also normally robust—typically steel. In this regard, improved steel alloys for use in railcar wheels have also been proposed. Exemplary steel alloys may be found for example, in U.S. Pat. Nos. 4,364,772 and 6,372,057.

In conflict with the design and use of overly robust railcar components and heavy component materials, is the desire to reduce rolling weight and, in turn, the amount of energy required to move a railcar or a train of railcars. The desire to reduce weight is not entirely new. For example, increasing the strength and durability of railcar wheels without increasing the corresponding weight thereof, has been previously discussed in for example, U.S. Pat. Nos. 2,768,020 and 3,038,755. In the case of the '020 and '755 patents, strength and durability improvements were claimed to be accomplished through wheel redesign, particularly the use of certain contours and/or the alignment of various wheel elements with one another in a particular manner.

While railcar wheel designs such as those presented in the '020 and '755 patents mentioned above have considered weight, such designs have also not resulted in any appreciable weight reduction. Likewise, while newly formulated steel alloys such as those described in the '772 and '057 patents mentioned above have been proposed for the purpose of improving railcar wheel strength and/or durability, such alloys have also failed to produce a railcar wheel or other railcar component whose weight is reduced in comparison to known components of comparable design or construction. Therefore, there continues to be a need for a railcar wheel that exhibits acceptable strength but reduced weight in comparison to comparable railcar wheels.

It is proposed that what is needed and has been heretofore absent from the art, are improved materials and associated manufacturing techniques that can be used to produce railcar components having improved strength and durability, but reduced weight. The invention is directed to the use of such materials and manufacturing techniques, and to railcar components produced accordingly.

### SUMMARY

The invention is directed to railcar components of improved strength and durability, as well as materials and manufacturing techniques for producing such railcar components. Railcar components of interest include, but are not limited to, railcar wheels. The invention is more particularly directed to railcar components manufactured from carbon nanofiber composites (mechanical mixtures of a metallic host material and carbon nanofibers), and to techniques for manufacturing railcar components from such composites.

Carbon nanofibers are well known, but may be generally described as carbon-based nanostructures of cylindrical shape and a plurality of stacked graphene layers. Carbon nanofibers are vapor grown and may take the form of carbon nanotubes, which may be single or multi-walled.

Importantly to the invention, carbon nanofibers are known to exhibit excellent mechanical properties, as well as high thermal conductivity. Carbon nanofibers are also readily dispersible within various other host materials, whereby the desirable properties of the nanofibers can be imparted to the host material so as to form an improved composite.

The mechanical strength of carbon nanofibers should be well known to one of skill in the art. It is also known that when carbon nanofibers are added to a host material to form a composite, the composite may exhibit mechanical properties (e.g., tensile strength, compression strength and modulus) that are superior to those of the host material alone. Similarly, carbon nanofibers also have high thermal conductivity and, therefore, can be used to produce a composite having a thermal conductivity that is superior to that of host material used in the composite.

The invention contemplates the use of such carbon nanofiber composites to produce railcar components, such as railcar wheels. Railcar components manufactured from such carbon nanofiber composites are expected to exhibit improved strength and durability, as well as increased thermal conductivity, in comparison to like railcar components comprised of steel and other known metal alloys.

Railcar components according to the invention may be manufactured, for example, by green sand mold casting or resin sand mold casting techniques. In either case, the composite material may be introduced to a casting mold manually or by automated or semi-automated means. One possible carbon nanofiber composite material of interest is described in U.S. Pat. No. 7,758,962, but the invention is not limited to any one composite or to any specific host material.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 depicts a simplistic example of a typical railcar wheel;

FIG. 2 represents the railcar wheel of FIG. 1 being formed via an exemplary casting operation according to the invention; and

FIG. 3 is a cross-sectional view of the wheel of FIG. 1, revealing the carbon nanofiber composite structure of the wheel.

### DETAILED DESCRIPTION OF EXEMPLARY EMBODIMENT(S)

As described above, the invention is directed to railcar components that are manufactured from carbon nanofiber composite materials, and to techniques for manufacturing railcar components from such materials. Railcar components of interest include but are not limited to railcar wheels. It is contemplated that similar materials and manufacturing techniques may also be used to produce other railcar components such as, without limitation, bolsters and coupling components (e.g., knuckles).

As previously discussed, carbon nanofibers are known to exhibit excellent mechanical properties, as well as high thermal conductivity. Carbon nanofibers are also readily dispersible within various other host materials, such as metals, plastics, elastomers and ceramics, whereby the strength and conductivity of the nanofibers can be imparted to the host material. Carbon nanofibers may be further tailored based on the material into which they will be dispersed and/or the application for which the carbon nanofiber/host material composition will be used.¹ ¹ http://www.sigmaaldrich.com/materials-science/nanomaterials/carbon-nanofibers.html

The mechanical strength of carbon nanofibers has been well documented.² It is also known that when carbon nanofibers are added to a host material to form a composite, the composite may exhibit mechanical properties (e.g., tensile strength, compression strength and modulus) that are superior to those of the host material alone. For example, experimentation has revealed that when such a composite is properly prepared, the tensile strength and modulus of the composite may be more than three times greater than that of the host material alone, and this improvement in mechanical properties may be achieved with only 15% by volume of carbon nanofibers.³ The thermal conductivity of such a composite may also be significantly greater than that of the host material alone.⁴ ² Ozkan, T.; Chen, Q.; Naraghi, M.; Chasiotis, I. In 53^{rd} International SAMPE Symposium Proceedings, Memphis, Tenn, Sep. 8-11, 2008.³ Tibbetts, G. G.; Lake, M. L.; Strong, K. L.; Rice, B. P; A review of the fabrication and properties of vapor-grown carbon nanofiber/polymer composites; Composites Science and Technology 2007, 67, 7-8; See also, http://www.sigmaaldrich.com; Finegan, I. C.; Tibbetts, G. G.; Glasgow, D. G.; Ting, J.-M.; Lake, M. L. J. Mater. Sci. 2003, 38, 3485; Kumar, S.; Doshi, H.; Srinivasarao, M.; Park, J. O.; Schiraldi, D. A. Pol. Comm. 2002, 43, 1701; Tibbetts, G. G.; McHugh, J. J. J. Mater. Res. 1999, 14, 1; Sadeghian, R; Minaie, B.; Gangireddy, S.; Hsiao, K.-T. In: 50th International SAMPE Symposium Proceedings, Long Beach, Calif., May 1-5, 2005; Li, B.; Wood, W.; Baker, L.; Sui, G.; Leer, C.; Zhong, W. H. Polym. Sci. Eng. 2010, 50, 1914; Gou, J.; O'Braint, S.; Gu, H.; Song, G. J. Nanomater. 2006, 32803, 1.⁴ Lafdi, K.; Matzek, M. In 48th International SAMPE Symposium Proceedings, Long Beach, Calif., May 11-15, 2003.

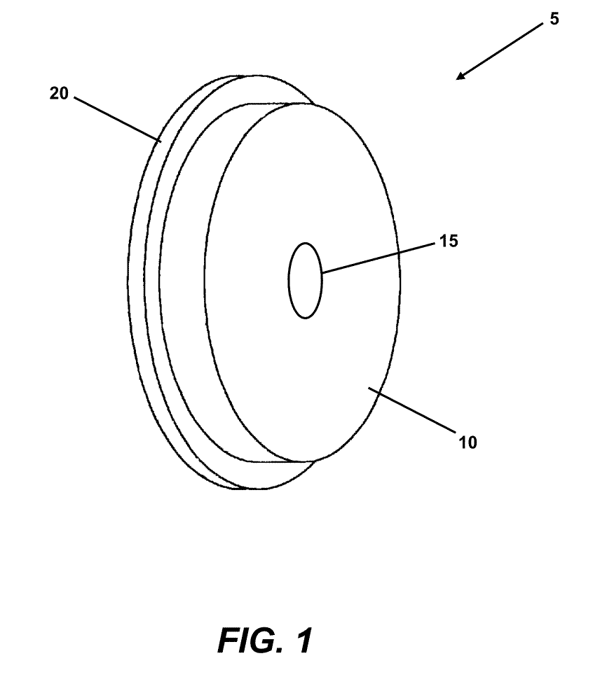

An exemplary railcar component in the form of a conventional railcar wheel 5 is illustrated in FIG. 1. The railcar wheel 5 is depicted herein in a very simplistic form for purposes of illustration, and it should be realized that such a railcar wheel may have a more complex design. Such railcar wheel designs may be found, for example, in the U.S. patents referenced in paragraph [0004] above.

In this particular example, the railcar wheel 5 is shown to include a hub portion 10 having an axial thru-hole 15 for receipt of an axle. The rim of the hub portion 10 is shown to have an extending flange portion 20, as would be well understood by one of skill in the art. Known railcar wheels of this or a similar type may be cast, pressed or machined from a steel or steel alloy.

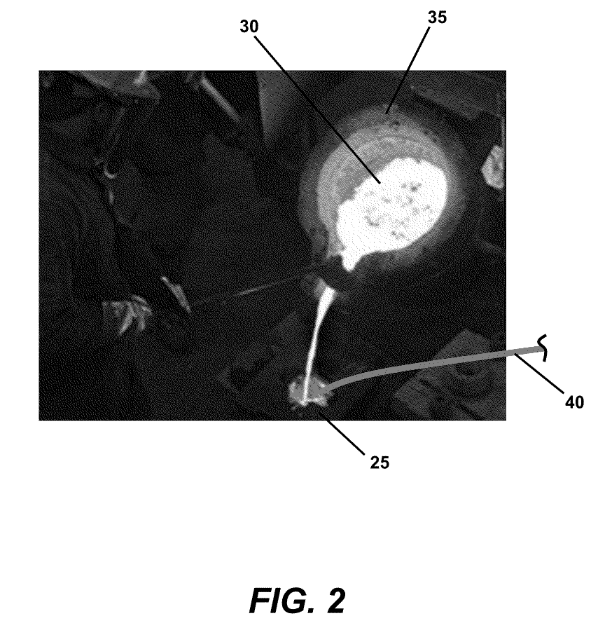

FIG. 2 represents an exemplary process of manufacturing the wheel 5 of FIG. 1 according to the invention. More specifically, FIG. 2 depicts a casting mold 25 and an exemplary casting process for producing the wheel 5 of FIG. 1. As shown, a molten host material 30 is being poured into the mold 25 from a ladle/crucible 35, and a carbon nanofiber material is being added by a carbon nanofiber dispensing device 40 to the molten host material as it enters the mold. Preferably, the carbon nanofiber material is added to the host material over time and at a controlled pace, rather than being added substantially all at once. The carbon nanofibers are thus dispersed within the host material so as to form a carbon nanofiber composite material, as described above. The composite material is allowed to cool within the mold 25, and the cast wheel is then removed and may be processed in any manner known in the art (e.g., cleaned, ground, machined, shot-peened, etc.). Transfer of the host material 30 and carbon nanofiber material into the mold 25 may be accomplished manually or by automated or semi-automated devices/systems.

A casting process such as that represented in FIG. 2 may be of different types. For example, green sand casting or resin sand casting techniques may be employed according to the invention. These casting techniques are well known in the art and, therefore, need not be described in detail herein. In brief, however, green sand casting simply indicates that wet sand (which typically includes clay as a binder) is used in the manufacture of the casting mold, while resin sand casting implies that a resin binder (e.g., a phenolic resin material) is mixed into the sand used to manufacture the casting mold.

When casting a railcar component such as, for example, the wheel 5 shown in FIG. 1, various other techniques may also be employed. For example, it is possible to produce and cast the wheel 5 entirely from one substantially homogeneous carbon nanofiber composite material—meaning that the carbon nanofibers are substantially equally dispersed within the host material. Alternatively, the wheel 5 may be cast in a non-homogeneous fashion, such as by employing higher density carbon nanofiber doping of the host material during certain portions of the casting operation so that particular parts of the wheel exhibit material properties that are dissimilar to other parts of the wheel. For example, an unequal dispersion of carbon nanofibers within the host material may be used to produce a wheel 5 where the hub or the flange/rim portions thereof are made more durable than other parts of the wheel. In yet other embodiments, the wheel 5 may be cast such that certain areas thereof do not contain carbon nanofibers or contain only a very small amount thereof. While the above-described dispersion variations have been explained herein in the context of manufacturing a railcar wheel, it is to be understood that these variations apply to other railcar components as well.

The use of more than one of carbon nanofiber material is also possible. For example, the wheel 5 may be cast such that a section(s) of the wheel that will be most directly subjected to or affected by heat during braking will include a carbon nanofiber material that provides enhanced thermal conductivity in comparison to the carbon nanofiber material used to cast other portions of the wheel. In such an embodiment, the same host material may be doped with the appropriate carbon nanofiber material at a point in the casting process that will result in proper location of the particular carbon nanofiber material within the desired area of the finished wheel. Alternatively, it is also possible that more than one host material may also be used in lieu of or in conjunction with more than one carbon nanofiber material to achieve a similar result. While the above-described material variations have been explained herein in the context of manufacturing a railcar wheel, it is to be understood that these variations apply to other railcar components as well.

Carbon nanofibers may be added to a host material in varying percentages according to the invention but, preferably, carbon nanofibers will make up approximately 1-2% by weight of the resulting composite material. It is most probable that the carbon nanofibers will become substantially randomly oriented within the host material after addition thereto.

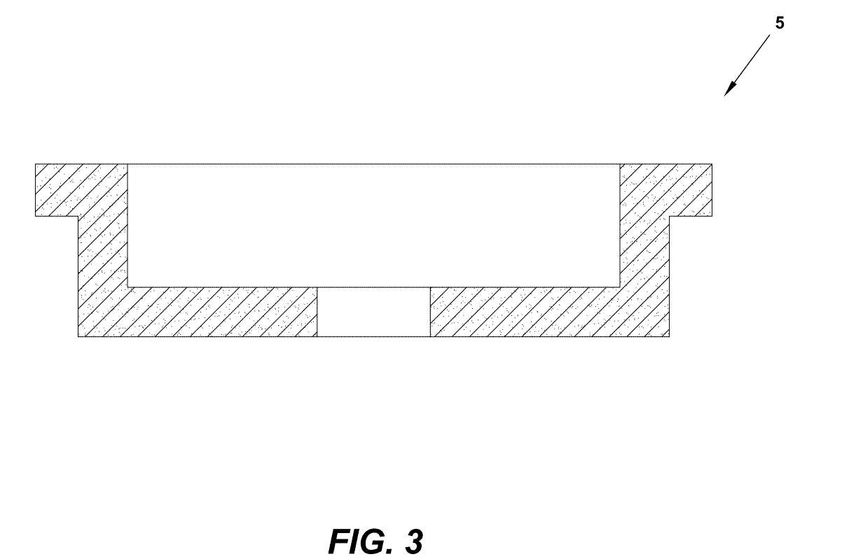

FIG. 3 is a cross-sectional view of an embodiment of the wheel 5 of FIG. 1, where the wheel has been cast from a substantially homogeneous carbon nanofiber and metal composite material. As such, it is represented in FIG. 3 by the scattering of dots that a large multitude of carbon nanofibers are dispersed throughout the metal-based host material, which itself is represented by the hatched lines. It should be noted that for purposes of illustration, FIG. 3 is not necessarily to scale and visual detection of the carbon nanofibers of the composite may not actually be possible in practice.

One possible carbon nanofiber composite material of interest is described in U.S. Pat. No. 7,758,962. The composite material of the '962 patent is a composite metal material having a carbon-based material (e.g., a carbon nanofiber material) dispersed in a matrix of a metal-based material. Consequently, such a composite material may be useful in the manufacture of railcar components according to the invention.

The invention is not limited to the use of any specific carbon nanofiber material, to any specific host material, or to any particular composite material resulting from the combination thereof. Additionally, while composite embodiments of the invention have been described above as utilizing carbon nanofibers, carbon nanotubes and macroscopic carbon fibers may be used instead.

While certain exemplary embodiments of the present invention are described in detail above, the scope of the invention is not to be considered limited by such disclosure, and modifications are possible without departing from the spirit of the invention as evidenced by the following claims:

What is claimed is:

1. A railcar wheel comprising:
a hub portion for connecting the wheel to an axle; and
a flange portion connected to the hub portion;
wherein at least a portion of the wheel is constructed from a carbon nanofiber composite material.

2. The railcar wheel of claim 1, wherein the carbon nanofiber composite material is comprised of carbon nanofibers dispersed within a metal-based host material.

3. The railcar wheel of claim 2, wherein the metal-based host material is a steel alloy.

4. The railcar wheel of claim 2, wherein the carbon nanofibers are dispersed within the metal-based host material in a substantially homogeneous manner.
